(19) United States
(12) Patent Application Publication
(10) Pub. No.: US 2015/0066425 A1
(43) Pub. Date: Mar. 5, 2015

(54) COMPUTING DEVICE AND METHOD FOR MEASURING FLATNESS OF OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/472,761

(22) Filed: Aug. 29, 2014

(30) Foreign Application Priority Data
Aug. 30, 2013 (CN) 2013103858503

(51) Int. Cl. G01B 11/30; G01B 11/24

(52) U.S. Cl. CPC G01B 11/306; G01B 11/24
USPC 702/150

(57) ABSTRACT

In a method for measuring flatness of an object placed on a detection device using a computing device, point cloud data in a specific range of the object is acquired from a laser scanning device of the detection device. The acquired point cloud data is fitted to be a plane, and a flatness value of the plane is calculated. The calculated flatness value is compared with a predetermined threshold value, and a determination result of whether the flatness of the object is qualified is output on a display screen of the computing device.

### CROSS-REFERENCE TO RELATED APPLICATIONS

This application claims priority to Chinese Patent Application No. 201310385850.3 filed on Aug. 30, 2013 in the State Intellectual Property Office of the People's Republic of China, the contents of which are incorporated by reference herein.

### FIELD

Embodiments of the present disclosure relate to measurement technology, and particularly to a computing device and a method for measuring flatness of an object placed on a detection device using the computing device.

### BACKGROUND

Flatness is a very important parameter for a reference plane and a fitting surface of a product. Therefore, after processing the product, the flatness of the product is required to be detected by a coordinate measuring machine (CMM). A CMM usually detects flatness using probes format various points on the product. The speed and accuracy of detecting the flatness are very low.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a computing device including a flatness measurement system.

FIG. 2 is a diagrammatic view of an embodiment of part of a detection device connected to the computing device.

FIG. 3 is a block diagram of one embodiment of the flatness measurement system of the computing device of FIG. 1.

FIG. 4 is a diagrammatic view of an embodiment of meshing projection points into a plurality of triangles.

FIG. 5 is a flowchart of one embodiment of a method for measuring flatness of an object placed on a detection device using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

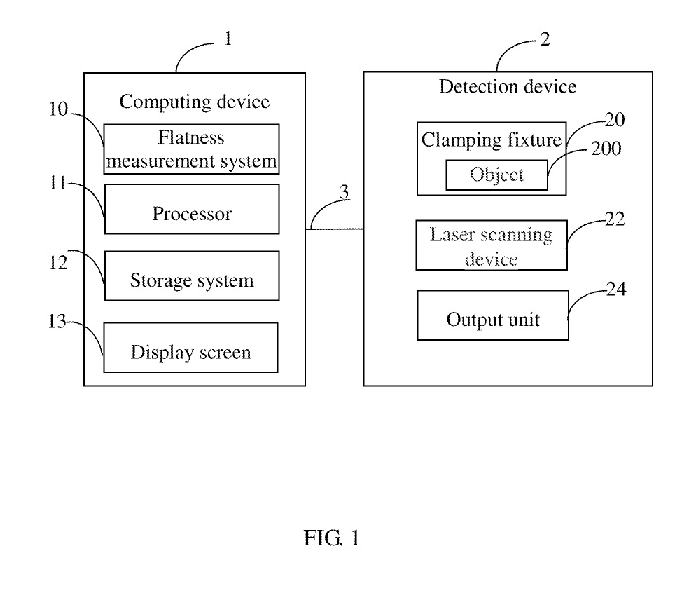

FIG. 1 is a block diagram of one embodiment of a computing device including a flatness measurement system. The computing device 1 includes, but is not limited to, a flatness measurement system 10, at least one processor 11, a storage system 12, and a display screen 13. The at least one processor 11 executes one or more computerized codes and other applications of the computing device 1 to provide functions of the flatness measurement system 10. The storage system 12 can be an internal storage system, such as a random access memory (RAM) for temporary storage of information, and/or a read only memory (ROM) for permanent storage of information. The storage system 12 can also be an external storage system, such as an external hard disk, a storage card, or a data storage medium.

In one embodiment, the computing device 1 is connected to a detection device 2 through a data cable 3. The detection device 2 can detect parameters (for example, point cloud data) of an object 200 placed on the detection device 2. In this embodiment, the detection device 2 includes, but is not limited to, a clamping fixture 20, a laser scanning device 22, and an output unit 24.

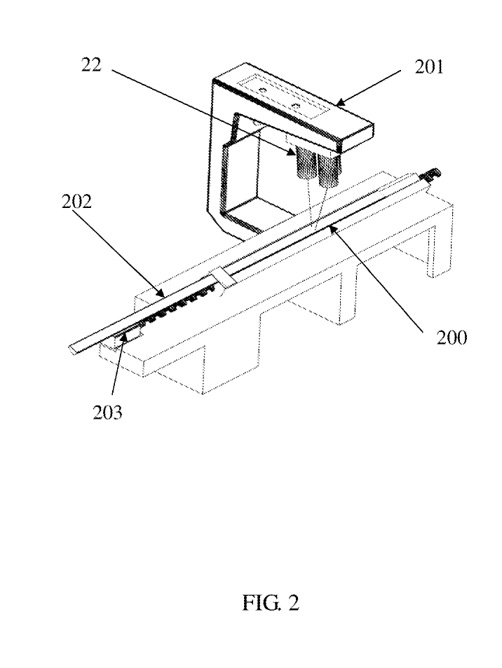

FIG. 2 is a diagrammatic view of an embodiment of part of a detection device. The clamping fixture 20 includes, but is not limited to, a laser fixing device 201, an X axial screw driving device 202, a motor 203. The laser fixing device 201 installs the laser scanning device 22. The laser scanning device 22 includes at least three laser measuring heads to project laser beams on the object 200 for scanning the object 200 linearly and collecting point cloud data of the object 200. The projection points projected on the objected of the three laser beams do not stand in a line.

The motor 203 can drive the X axial screw driving device 202 for controlling the object 200 to move, and the laser scanning device 22 can collect the point cloud data of a specific range on the object 200. The output unit 24 can output data detected by the detection device 2 to the computing device 1. For example, the output unit 24 outputs the collected point cloud data to the computing device 1.

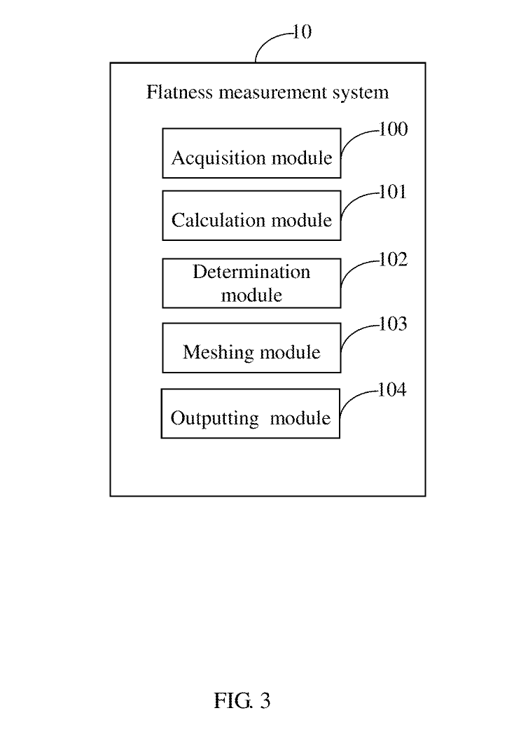

FIG. 3 is a block diagram of one embodiment of a flatness measurement system of a computing device of FIG. 1. In this embodiment, the flatness measurement system 10 includes, but is not limited to, an acquisition module 100, a calculation module 101, a determination module 102, a meshing module 103, and an outputting module 104. The modules 100-104 include computerized code in the form of one or more programs that are stored in the storage system 12. The computerized code includes instructions that are executed by the at least one processor 11 to provide functions of the flatness measurement system 10.

The acquisition module 100 configures to start the detection device 2 and the laser scanning device 22 scanning a specific range on the object 200, and acquire point cloud data in the scanned range of the object 200 from the output unit 24 of the detection device 2. In the embodiment, the specific range can be determined according to user's requirements.

The calculation module 101 configures to fit the acquired point cloud data to be a plane, and calculate a flatness value of the plane. In one embodiment, the calculation module 101 fits the plane according to the least-square method and a Quasi-Newton iterative method. The flatness value is calculated by subtracting a minimum distance between one point in the acquired point cloud data and the plane from a maximum distance between one point in the acquired point cloud data and the plane according to a predetermined formula of “d=(A*X₀+B*Y₀+C−Z₀)/\sqrt{A*A+B*B+1}”. “A”, “B” and “C” in the formula represent virtual coordinate values of one point on the plane, “X₀”, “Y₀” and “Z₀” in the formula represent coordinate values of a corresponding point in the acquired point cloud data.

For example, it is assumed that there are N scanning points representing as “Pᵢ(xᵢ, yᵢ, zᵢ)(i=1, 2, . . . , N)” on the plane, an equation of a perfect plane is z=Ax+By+C. “A”, “B” and “C” in the equation are constant variables to be determined. According to the least-square method, an object function F(A, B, C) is calculated according to a preset formula of

$$“ F ( A , B , C ) = {\sum }_{i = 1}^{N} {( {Ax}_{i} + {By}_{i} + C - {Z}_{i} )}^{2} ” . Where \frac{\partial F}{\partial A} = 0 , \frac{\partial F}{\partial B} = 0 , \frac{\partial F}{\partial C} = 0 ,$$

a value of F(A, B, C) is minimum. Therefore, the constant variables of the plane can be determined according to a follow equation of

$$“ \begin{matrix}A = \frac{{S}_{12} {S}_{23} - {S}_{13} {S}_{22}}{{S}_{12}^{2} - {S}_{11} {S}_{22}} \\ B = \frac{{S}_{12} {S}_{13} - {S}_{11} {S}_{23}}{{S}_{12}^{2} - {S}_{11} {S}_{22}} \\ C = \frac{{\sum }_{i = 1}^{N} {z}_{i} - A {\sum }_{i = 1}^{N} {x}_{i} - B {\sum }_{i = 1}^{N} {y}_{i}}{N}\end{matrix} \} ” ,$$

wherein

$${S}_{11} = {\sum }_{i = 1}^{N} {x}_{i}^{2} - \frac{1}{N} {( {\sum }_{i = 1}^{N} {x}_{i} )}^{2} , {S}_{12} = {\sum }_{i = 1}^{N} {x}_{i} {y}_{i} - \frac{1}{N} {\sum }_{i = 1}^{N} {x}_{i} {\sum }_{i = 1}^{N} {y}_{i} , {S}_{13} = {\sum }_{i = 1}^{N} {x}_{i} {z}_{i} - \frac{1}{N} {\sum }_{i = 1}^{N} {x}_{i} {\sum }_{i = 1}^{N} {z}_{i} , {S}_{22} = {\sum }_{i = 1}^{N} {y}_{i}^{2} - \frac{1}{N} {( {\sum }_{i = 1}^{N} {y}_{i} )}^{2} , and {S}_{23} = {\sum }_{i = 1}^{N} {y}_{i} {z}_{i} - \frac{1}{N} {\sum }_{i = 1}^{N} {y}_{i} {\sum }_{i = 1}^{N} {z}_{i} .$$

Therefore, a unit normal vector(l, m, n) of the plane is calculated according to the equations of

$$“ \begin{matrix}l = \frac{A}{\sqrt{{A}^{2} + {B}^{2} + 1}} \\ m = \frac{B}{\sqrt{{A}^{2} + {B}^{2} + 1}} \\ n = \frac{- 1}{\sqrt{{A}^{2} + {B}^{2} + 1}} \end{matrix} \} ” .$$

The determination module 102 configures to compare the calculated flatness value with a predetermined threshold value (for example, 0.1 mm), and output an indication on the display screen 13 as to whether the flatness of the object is qualified. If the calculated flatness value is greater than or equal to the predetermined threshold value, the determination module 102 outputs a determination result indicating that the flatness of the plane is qualified. If the calculated flatness value is less than the predetermined threshold value, the determination module 102 outputs the determination result indicating that the flatness of the plane is unqualified.

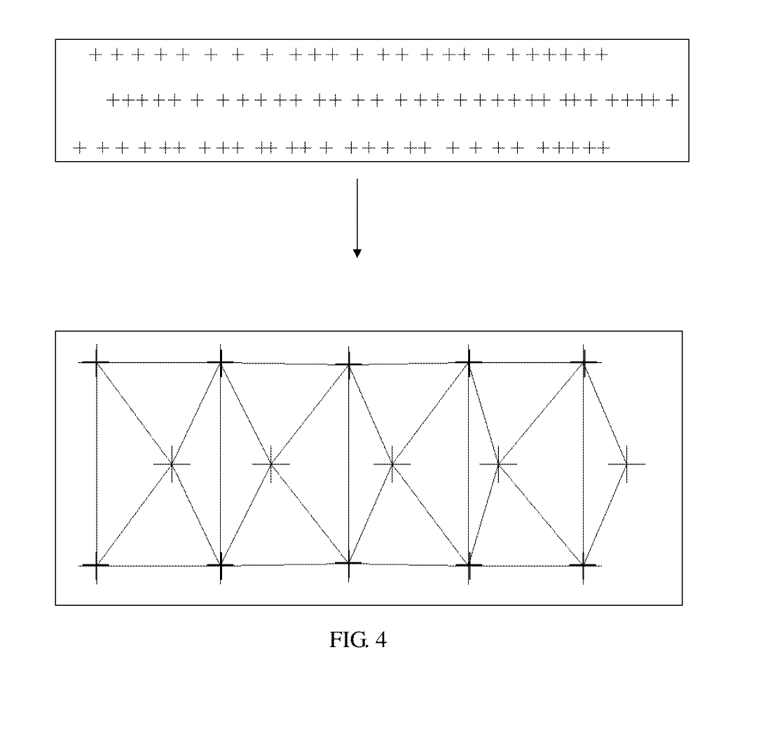

The meshing module 103 configures to mesh the acquired point cloud data into a plurality of triangles, and output a triangle queue including all of the triangles. In the embodiment, the point cloud data collected by the laser scanning device 22 are not disorderly but have a certain rule. Therefore, the meshing module 103 meshes the acquired point cloud data by obtaining a free point from the acquired point cloud data which has not formed a triangle with other points, and calculating the nearest three point from the free point. The meshing module 103 further connects the acquired four points counterclockwise to form two triangles. All of the triangles are formed using the above-mentioned method, and the triangle queue including all of the triangles for the acquired point cloud data is output. For example, the meshed point cloud data is shown in FIG. 4. In other embodiment, the meshing module 103 can use other meshing methods for meshing the acquired point cloud data into the plurality of triangles.

The outputting module 104 configures to calculate a distance between a center of each triangle and the plane from the triangle queue. The outputting module 104 further configures to mark a color of each triangle according to the calculated distance and a corresponding preset color, and display the marked triangles on the display screen 13. In one embodiment, distances in different ranges can correspond to different preset colors. According to the marked triangles, users can know detailed flatness of the object 200 clearly.

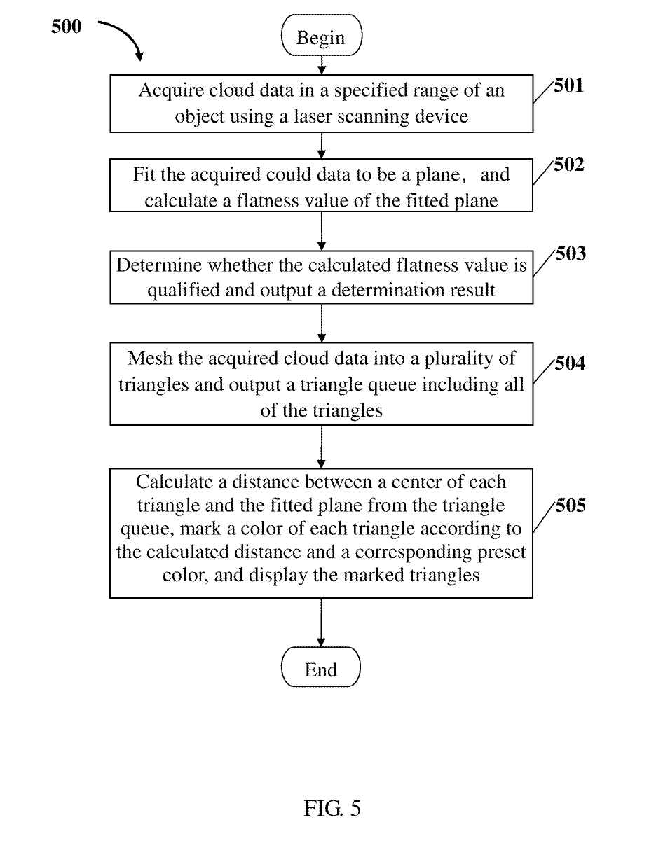

FIG. 5 is a flowchart of one embodiment of a method 500 for measuring flatness of an object placed on a detection device using a computing device. Depending on the embodiment, additional blocks can be added, others removed, and the ordering of the blocks can be changed. In the embodiment, the method 500 is performed by execution of computer-readable software program codes or instructions by at least one processor of a computing device. The method 500 is provided by way of example, as there are a variety of ways to carry out the method. The method 500 described below can be carried out using the configurations illustrated in FIG. 1-FIG. 4, for example, and various elements of these figures are referenced in explaining method 500. Each block shown in FIG. 5 represents one or more processes, methods or subroutines, carried out in the method 500. Additionally, the illustrated order of blocks is by example only and the order of the blocks can change according to the present disclosure. The example method 500 can begin at block 501.

In block 501, an acquisition module starts the detection device 2 and the laser scanning device 22 scanning a specific range on the object 200, and acquires point cloud data in the scanned range of the object 200 from the output unit 24. In the embodiment, the specific range can be determined according to user's requirements.

In block 502, a calculation module fits the acquired point cloud data to be a plane, and calculates a flatness value of the plane. In one embodiment, the calculation module fits the plane according to the least-square method and a Quasi-Newton iterative method. The flatness value is calculated by subtracting a minimum distance between one point in the acquired point cloud data and the plane from a maximum distance between one point in the acquired point cloud data and the plane according to a predetermined formula of “d=(A*X₀+B*Y₀+C−Z₀)/\sqrt{A*A+B*B+1}”. “A”, “B” and “C” in the formula represent virtual coordinate values of one point on the plane, “X₀”, “Y₀” and “Z₀” in the formula represent coordinate values of a corresponding point in the acquired point cloud data.

In block 503, a determination module compares the calculated flatness value with a predetermined threshold value, and outputs an indication using the display screen 13. If the calculated flatness value is greater than or equal to the predetermined threshold value, the determination module outputs the indication that the flatness of the plane is qualified. If the calculated flatness value is less than the predetermined threshold value, the determination module outputs the indication that the flatness of the plane is unqualified.

In block 504, a meshing module meshes the acquired point cloud data into a plurality of triangles, and outputs a triangle queue including all of the triangles.

In block 505, a outputting module calculates a distance between a center of each triangle and the plane from the triangle queue, marks a color of each triangle according to the calculated distance and a corresponding preset color, and displays the marked triangles on the display screen 13.

All of the processes described above can be embodied in, and fully automated via, functional code modules executed by one or more general purpose processors such as the processor 11. The code modules can be stored in any type of non-transitory readable medium or other storage system such as the storage system 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications within this disclosure. All such modifications and variations are intended to be included within the scope of this disclosure and the described inventive embodiments, and the present disclosure is protected by the following claims and their equivalents.

What is claimed is:

1. A computer-implemented method for measuring flatness of an object placed on a detection device using a computing device, the method comprising:
acquiring point cloud data pertaining to the object in a specific range using a laser scanning device of the detection device;
fitting the acquired point cloud data to be a plane, and calculating a flatness value of the plane;
comparing the calculated flatness value with a predetermined threshold value; and
outputting an indication on a display screen of the computing device as to whether the flatness of the object is qualified.

2. The method according to claim 1, further comprising:
meshing the acquired point cloud data into a plurality of triangles, and outputting a triangle queue including all of the triangles;
calculating a distance between a center of each of the triangles and the plane from the triangle queue, and marking a color of each of the triangles according to the calculated distance of each of the triangles and a corresponding preset color; and
displaying the marked triangles on the display screen.

3. The method according to claim 2, wherein the acquired point cloud data is meshed by:
obtaining a free point from the acquired point cloud data which has not formed a triangle with other points, and calculating the nearest three point from the free point;
connecting the acquired four points counterclockwise to form two triangles; and
storing all of the triangles in the acquired point cloud data in the triangle queue.

4. The method according to claim 2, wherein the distance between the center of each of the triangles and the plane in different ranges corresponds to different preset colors.

5. The method according to claim 1, wherein the laser scanning device comprises at least three laser measuring heads to project laser beams on the object for scanning the object linearly and collecting the point cloud data of the object, wherein the projection points projected on the objected of the three laser beams do not stand in a line.

6. The method according to claim 1, wherein the flatness value is calculated by subtracting a minimum distance between one point in the acquired point cloud data and the plane from a maximum distance between one point in the acquired point cloud data and the plane.

7. A non-transitory computer-readable storage medium storing a set of instructions, when executed by at least one processor of a computing device, cause the at least one processor to perform a method for measuring flatness of an object placed on a detection device, the method comprising:
acquiring point cloud data pertaining to the object in a specific range using a laser scanning device of the detection device;
fitting the acquired point cloud data to be a plane, and calculating a flatness value of the plane;
comparing the calculated flatness value with a predetermined threshold value; and
outputting an indication on a display screen of the computing device as to whether the flatness of the object is qualified.

8. The storage medium according to claim 7, wherein the method further comprises:
meshing the acquired point cloud data into a plurality of triangles, and outputting a triangle queue including all of the triangles;
calculating a distance between a center of each of the triangles and the plane from the triangle queue, and marking a color of each of the triangles according to the calculated distance of each of the triangles and a corresponding preset color; and
displaying the marked triangles on the display screen.

9. The storage medium according to claim 8, wherein the acquired point cloud data is meshed by:
obtaining a free point from the acquired point cloud data which has not formed a triangle with other points, and calculating the nearest three point from the free point;
connecting the acquired four points counterclockwise to form two triangles; and
storing all of the triangles in the acquired point cloud data in the triangle queue.

10. The storage medium according to claim 8, wherein the distance between the center of each of the triangles and the plane in different ranges corresponds to different preset colors.

11. The storage medium according to claim 7, wherein the laser scanning device comprises at least three laser measuring heads to project laser beams on the object for scanning the object linearly and collecting the point cloud data of the object, wherein the projection points projected on the objected of the three laser beams do not stand in a line.

12. The storage medium according to claim 7, wherein the flatness value is calculated by subtracting a minimum distance between one point in the acquired point cloud data and the plane from a maximum distance between one point in the acquired point cloud data and the plane.

13. A computing device being connected to a detection device, the computing device comprising:
at least one processor; and
a storage system storing one or more programs, which when executed by the at least one processor, cause the at least one processor to:
acquire point cloud data pertaining to the object in a specific range using a laser scanning device of the detection device;
fit the acquired point cloud data to be a plane, and calculating a flatness value of the plane;
compare the calculated flatness value with a predetermined threshold value; and
output an indication on a display screen of the computing device as to whether the flatness of the object is qualified.

14. The computing device according to claim 13, wherein the one or more programs further cause the at least one processor to:
mesh the acquired point cloud data into a plurality of triangles, and output a triangle queue including all of the triangles;
calculate a distance between a center of each of the triangles and the plane from the triangle queue, and mark a color of each of the triangles according to the calculated distance of each of the triangles and a corresponding preset color; and
display the marked triangles on the display screen.

15. The computing device according to claim 14, wherein the acquired point cloud data is meshed by:
obtaining a free point from the acquired point cloud data which has not formed a triangle with other points, and calculating the nearest three point from the free point;
connecting the acquired four points counterclockwise to form two triangles; and
storing all of the triangles in the acquired point cloud data in the triangle queue.

16. The computing device according to claim 14, wherein the distance between the center of each of the triangles and the plane in different ranges corresponds to different preset colors.

17. The computing device according to claim 13, wherein the laser scanning device comprises at least three laser measuring heads to project laser beams on the object for scanning the object linearly and collecting the point cloud data of the object, wherein the projection points projected on the objected of the three laser beams do not stand in a line.

18. The computing device according to claim 13, wherein the flatness value is calculated by subtracting a minimum distance between one point in the acquired point cloud data and the plane from a maximum distance between one point in the acquired point cloud data and the plane.
